(19) United States
(12) Patent Application Publication
(10) Pub. No.: US 2026/0268751 A1
(43) Pub. Date: Sep. 10, 2026

(54) HYDROGEN FUEL CELL SERVICE BAY

(71) Applicant: Marathon Finishing Systems, Inc., Temecula, CA (US)

(72) Inventor: Christian Rerucha, Temecula, CA (US)

(21) Appl. No.: 19/069,416

(22) Filed: Mar. 4, 2025

(51) Int. Cl. G08B 17/10; G08B 5/36

(52) U.S. Cl. CPC G08B 17/10; G08B 5/36

(57) ABSTRACT

A Fuel Cell Electric Vehicles (FCEV) service bay system includes a vehicle bay roof structure that defines a first height from a ground surface; a safety curtain mounted at least partially about a periphery of the vehicle bay roof structure, the safety curtain extends from the vehicle bay roof structure, the safety curtain defines a second height from the ground surface less than the first height; a gas exhaust system mounted to the vehicle bay roof structure; a gas detection system mounted to the vehicle bay roof structure; and a control system in communication with the gas exhaust system and the gas detection system.

### CROSS REFERENCE TO RELATED APPLICATION[S]

None

### BACKGROUND

The present disclosure relates to the service of Fuel Cell Electric Vehicles and more specifically to a service bay which collects hydrogen therefrom.

Hydrogen (H2) fuel cell vehicles (“Fuel Cell Electric Vehicles” or FCEV) vehicles are becoming more commonplace. These vehicles have stacks of fuel cells that contain hydrogen. Instead of burning the hydrogen for fuel, the cells chemically fuse the hydrogen molecules with oxygen from the air. This process produces electricity, which then is used to power the vehicle's electric motors. The only byproduct that is produced is water, resulting in pollution-free emissions.

Hydrogen, like many lighter-than-air fuels, is flammable, and can ignite if it comes into contact with an electrical spark. This makes it important for service providers to have safety systems in place before technicians begin their work on FCEVs. Unlike petroleum products that are heavier than air and will pool on the ground if released, hydrogen is a lighter-than-air fuel that, if released, rises upward, pooling on the ceiling. If you have service bays with openings at the top, the hydrogen fuel will escape elsewhere and may pose a risk of ignition such as if the hydrogen comes into contact with lighting fixtures.

Before an FCEV is serviced, the hydrogen must be drained out of the fuel cell stack. After the hydrogen fuel has been removed from the cell stack, the stack has to be neutralized with helium. Once the cell stack is neutralized, technicians can safely proceed with their service activities.

Because of the potential risks of ignition from an electric spark or heat source, it is important for facilities that offer repair and maintenance services to have dedicated H2 fuel service bays installed.

This background section is intended to introduce the reader to various aspects of art that may be related to various aspects of the present disclosure, which are described and/or claimed below. This discussion is believed to assist the reader with background information to facilitate a better understanding of the various aspects of the present disclosure. Accordingly, it should be understood that these statements are to be read in this light, and not as admissions of prior art.

### SUMMARY

A Fuel Cell Electric Vehicles (FCEV) service bay system according to one disclosed non-limiting embodiment of the present disclosure includes a vehicle bay roof structure that defines a first height from a ground surface; a safety curtain mounted at least partially about a periphery of the vehicle bay roof structure, the safety curtain extends from the vehicle bay roof structure, the safety curtain defines a second height from the ground surface less than the first height; a gas exhaust system mounted to the vehicle bay roof structure; a gas detection system mounted to the vehicle bay roof structure; and a control system in communication with the gas exhaust system and the gas detection system.

A further embodiment of any of the foregoing embodiments of the present disclosure includes that the second height is less than one-third of the first height.

A further embodiment of any of the foregoing embodiments of the present disclosure includes that a ratio of the safety curtain height to the height of the roof structure is between 0.2-0.5.

A further embodiment of any of the foregoing embodiments of the present disclosure includes that a ratio of the safety curtain height to the height of the roof structure is 0.3.

A further embodiment of any of the foregoing embodiments of the present disclosure includes a light system in communication with the control system.

A further embodiment of any of the foregoing embodiments of the present disclosure includes a warning light Christmas tree in communication with the control system.

A further embodiment of any of the foregoing embodiments of the present disclosure includes that the gas detection system is operable to detect a preset lower flammability level (LFL) saturation level.

A method for providing a predetermined lower flammability level (LFL) saturation level within a service bay for Fuel Cell Electric Vehicles (FCEV) according to one disclosed non-limiting embodiment of the present disclosure includes capturing lighter-than-air fuel within a predetermined height of a gas exhaust system mounted in a vehicle bay roof structure, the predetermined height less than a height of the vehicle bay roof structure to the ground; and evacuating the lighter-than-air fuel to the atmosphere.

A further embodiment of any of the foregoing embodiments of the present disclosure includes that the capturing comprises extending a safety curtain from the vehicle bay roof structure.

A further embodiment of any of the foregoing embodiments of the present disclosure includes that a ratio of the safety curtain height to the height of the roof structure is 0.3.

A further embodiment of any of the foregoing embodiments of the present disclosure includes that the safety curtain extends for at least the predetermined height.

A further embodiment of any of the foregoing embodiments of the present disclosure includes that the evacuating comprises an updraft style air flow.

A further embodiment of any of the foregoing embodiments of the present disclosure includes detecting a lower flammability level (LFL) and issuing an alarm at a predetermined lower flammability level (LFL).

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of an FCEV service bay system according to one disclosed non-limiting embodiment.

FIG. 2 is a schematic view of a control panel and warning system for an FCEV service bay system according to one disclosed non-limiting embodiment.

FIG. 3 is a schematic view of the FCEV service bay system.

FIG. 4A is a front perspective view of the FCEV service bay system.

FIG. 4B is a rear perspective view of the FCEV service bay system.

FIG. 5A is a side schematic view of the FCEV service bay system illustrating airflow therein.

FIG. 5B is a front schematic view of the FCEV service bay system illustrating airflow therein.

FIG. 6A is a side schematic view of the FCEV service bay system illustrating a safety curtain arrangement according to one disclosed non-limiting embodiment.

FIG. 6B is a front schematic view of the FCEV service bay system illustrating the safety curtain arrangement of FIG. 6A.

FIG. 7 is a side schematic view of the FCEV service bay system illustrating airflow therein.

FIG. 8 is a schematic block diagram view of the FCEV service bay system operations.

FIG. 9 is a schematic view of the FCEV service bay system operations control system in an auto-mode.

FIG. 10 is a schematic view of the FCEV service bay system operations control system in a normal operations mode.

FIG. 11 is a schematic view of the FCEV service bay system operations control system in an alarm 1 operations mode.

FIG. 12 is a schematic view of the FCEV service bay system operations control system in an alarm 2 operations mode.

FIG. 13 is a schematic view of the FCEV service bay system operations control system in a critical fault mode.

### DETAILED DESCRIPTION

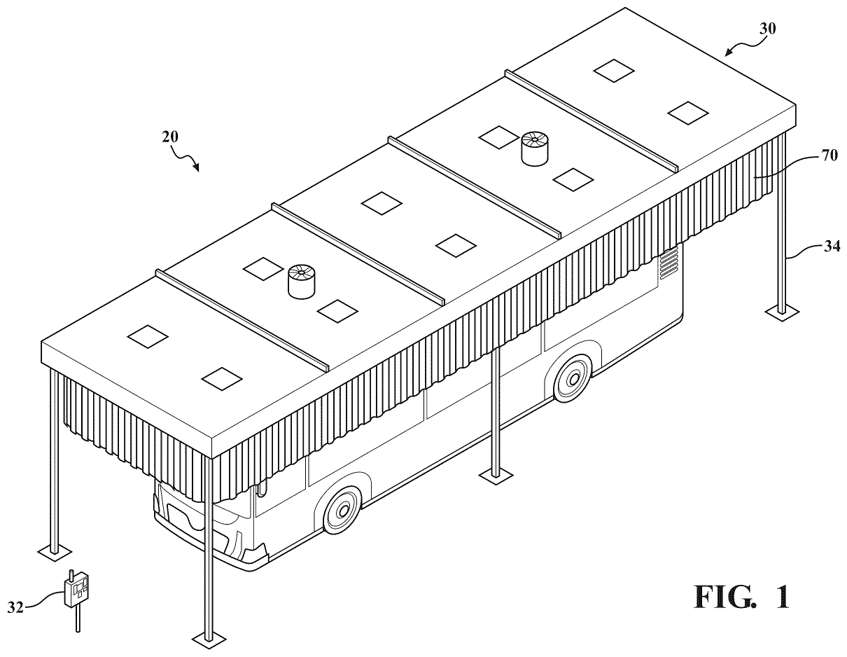

FIG. 1 schematically illustrates a Fuel Cell Electric Vehicles (FCEV) service bay system 20 within which vehicles may be serviced. Although a mass transport vehicle such as a bus is illustrated in the disclosed embodiment, other service bays for other vehicles may also benefit herefrom.

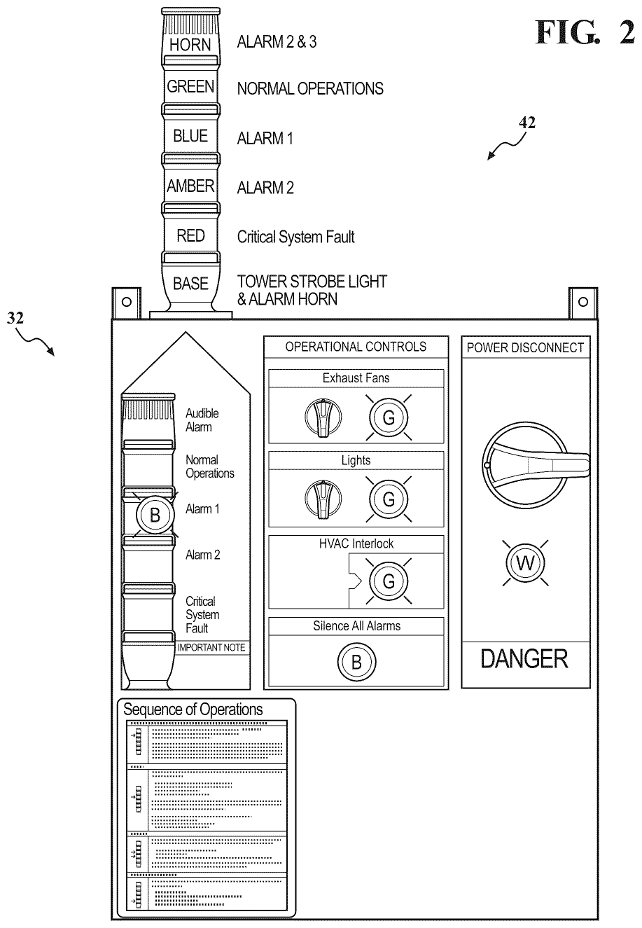

The FCEV service bay system 20 generally includes a vehicle bay structure 30 and a control system 32 (FIG. 2). The vehicle bay structure 30 generally includes a framework 34 that may be installed in a repair facility to safely provide mechanical services for FCEV that utilize lighter than air fluids.

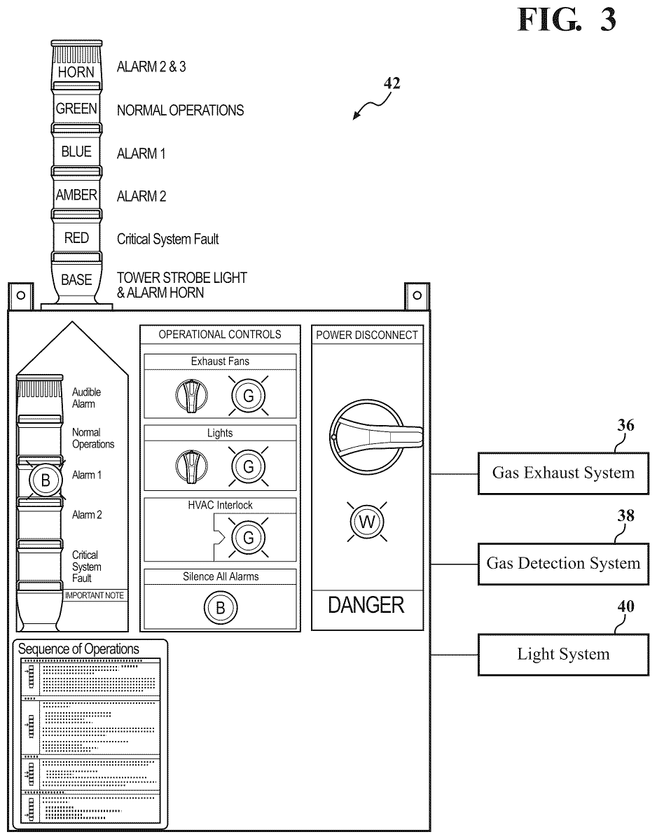

With reference to FIG. 3, the control system 32 communicates with a gas exhaust system 36, a gas detection system 38, a light system 40 and a warning system 42. The control system 32 communicates with the gas detection system 38 that may include one or more highly sensitive sensors that monitor the work environment constantly to automatically activate the warning system 42 and the gas exhaust system 36 to automatically remove hydrogen gas that may have escaped or may otherwise accumulate and create a hazard. This is a completely automated process for enhanced safety.

The control system 32 may include at least one processor, e.g., microprocessor, microcontroller, digital signal processor, etc., a memory, and an input/output (I/O) interface. The processor and the I/O interface are communicatively coupled to the memory. The memory may be embodied as various forms of ROM, RAM, which stores data and control algorithms such as the logic described herein to control, for example the warning system 42 and the gas exhaust system 36. The I/O interface is communicatively coupled to a number of hardware, firmware, and/or software components, including, for example, the warning system 42 and the gas exhaust system 36. That is, the control system 32 may provide programmable modifications to operational functions of the gas exhaust system 36, the gas detection system 38, the light system 40 and the warning system 42.

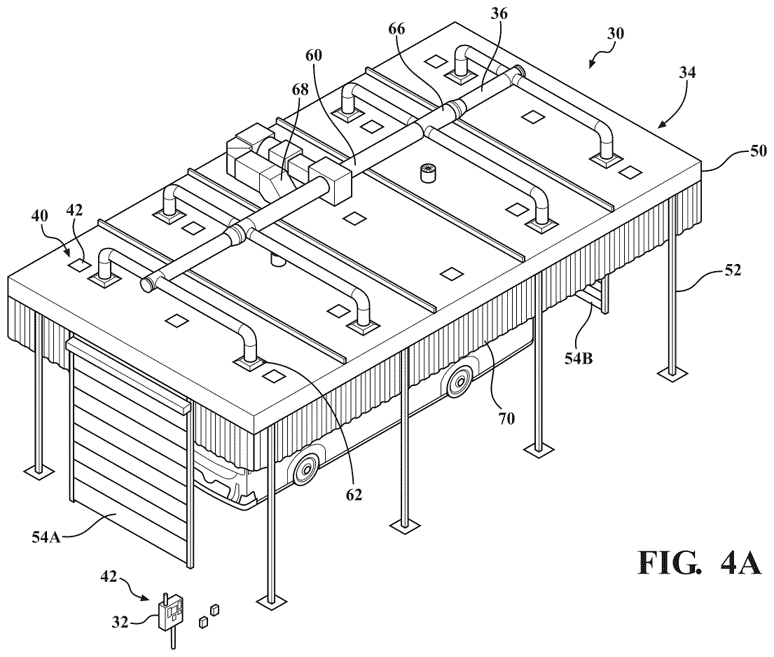

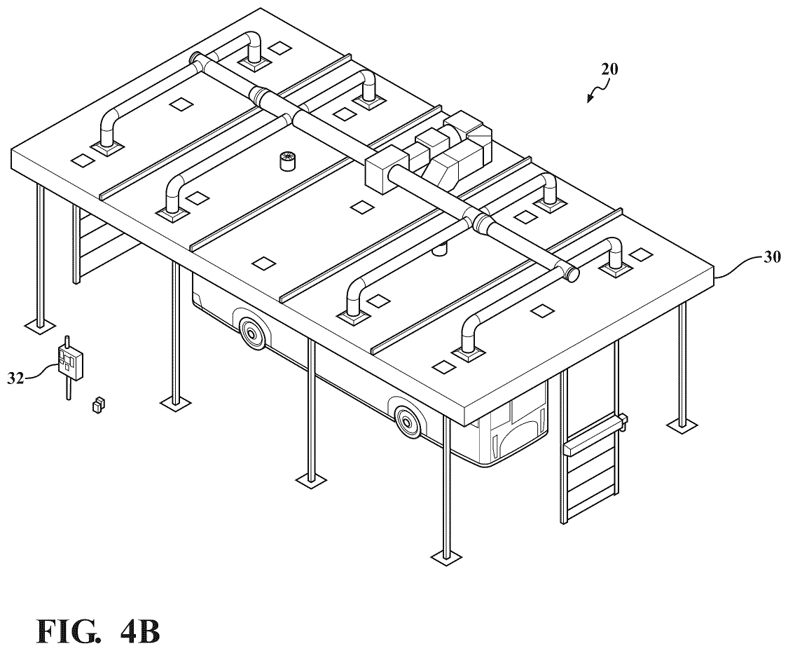

With reference to FIGS. 4A and 4B, the framework 34 may include a roof structure 50 and support legs 52. The gas exhaust system 36, the gas detection system 38, and the light system 40 may be supported by the framework 34.

In one embodiment, the framework 34 may be manufactured of 18 gauge galvanized steel that is bright white powder coated. Although a particular rectilinear structure is illustrated in the disclosed embodiment, the vehicle bay structure 30 may be of various shapes and configurations to accommodate various vehicles. In one embodiment, roll up doors 54A, 54B are provided to provide entry and egress of the vehicle.

The gas exhaust system 36, the gas detection system 38, and the light system 40 are mounted in the roof structure 50 to provide an expansive safe and well-lit work area around the vehicle.

The light system 40 may include, for example, UL Certified C1D2 Bright LED lights 42 arranged in a rectilinear pattern. That are highly efficient and provide the work areas with ample light with minimal shadowing. These lights have an exceptionally long service life and save on energy costs. In one embodiment, thirteen lights are provided in a rectilinear pattern.

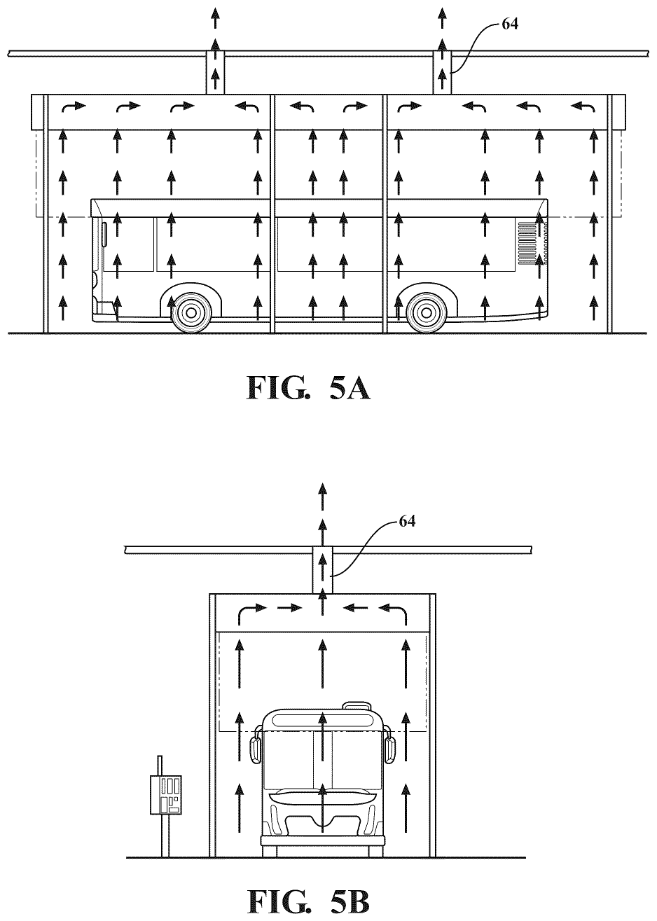

The gas exhaust system 36 may include a duct work 60 that interconnects a multiple of vents 62 that exhaust though one or more exhaust stacks 64 (FIGS. 5A and 5B) to the outside atmosphere via a multiple of circulation fans 66 (two shown). The gas detection system 38 may include a Lower Explosive Limit (LEL) combustible (catalytic) 68 (two shown) in communication with the duct work 60.

The gas exhaust system 36 captures and exhausts hydrogen released from the vehicle safely into the outside atmosphere, where it safely dispersed (FIGS. 5A and 5B). In one example, the fans are belt-driven tubeaxial fans with belt tunnels that ventilate the drive compartment with air from outside the fan. In this example, the gas exhaust system 36 may provide a base airflow of 2126 CFM during standard operation and 4252 CFM during alarm purge operation.

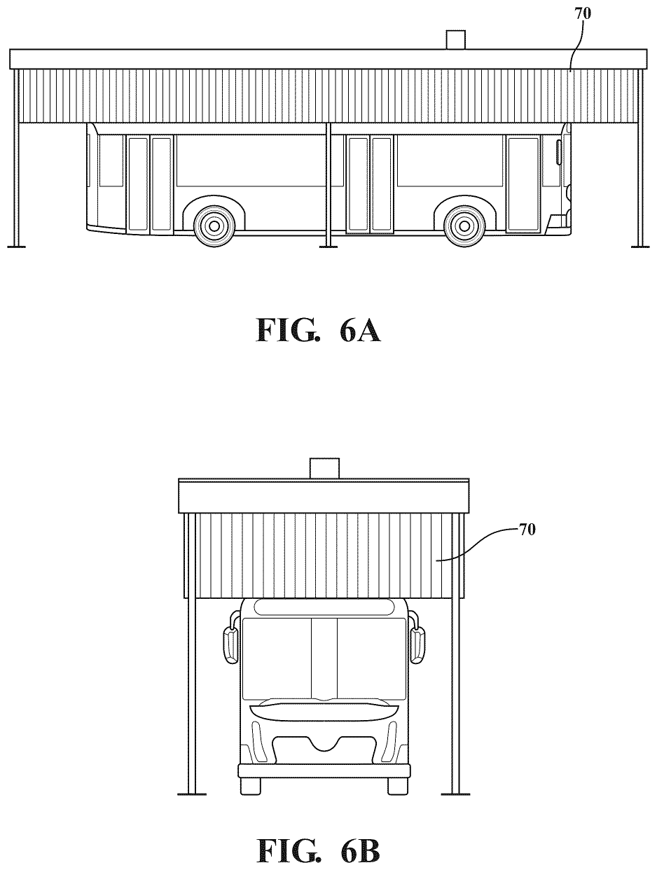

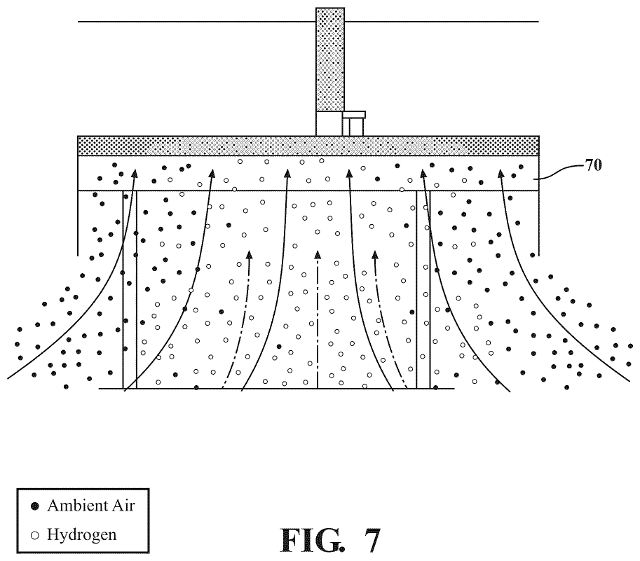

With reference to FIGS. 6A and 6B, a safety curtain 70 such as that manufactured by Goff industrial of Pewaukee WI, USA, extends from a periphery of the roof structure 50. The safety curtain 70 creates a safety envelope that captures any released hydrogen and directs it into the gas exhaust system 36, where it is exhausted outside the building and safely dispersed into the outside atmosphere (FIGS. 5A, 5B and 7).

The safety curtain 70 extends from the roof structure 50 for a height less than the height of the roof structure 50 from the ground surface. That is, the safety curtain 70 need not extend to the ground. In one embodiment, the safety curtain 70 extends less than one-third of the distance from the roof structure 50 to the ground surface. More specifically, the safety curtain 70 may extend for 18 inches from the roof structure 50 which may be 13 feet 7 inches from the ground. In one embodiment, the ratio of the safety curtain 70 height to the height of the roof structure 50 may be between 0.2-0.5, more specifically, 0.3. The length of the safety curtain 70 facilitates a higher airflow/larger space, less moving parts, and lower amperage fans 66 for more efficient system operation. The safety curtain 70 contains the hydrogen gas adjacent, e.g., within 18 inches of the gas exhaust system 36 and the gas detection system 38 to assure efficient detection and removal. The safety curtain 70 further facilitates an updraft style air flow.

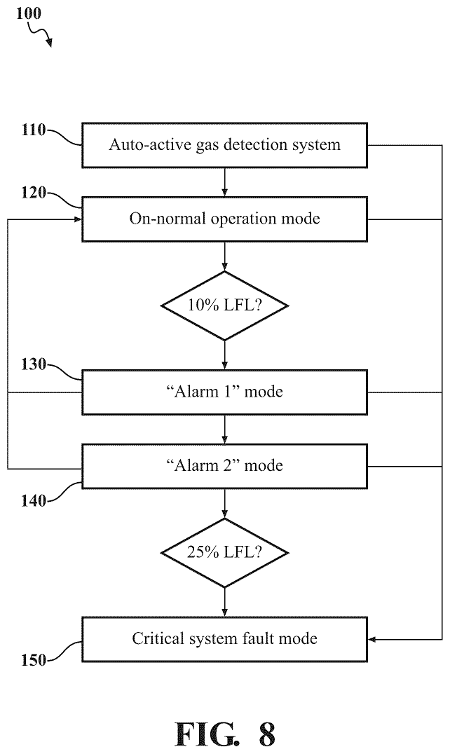

With reference to FIG. 8 a method 100 for operating the FCEV service bay system 20 is schematically illustrated. The functions may be programmed software routines capable of execution in various microprocessor-based electronics control embodiments and are represented herein as block diagrams.

### Auto-Mode

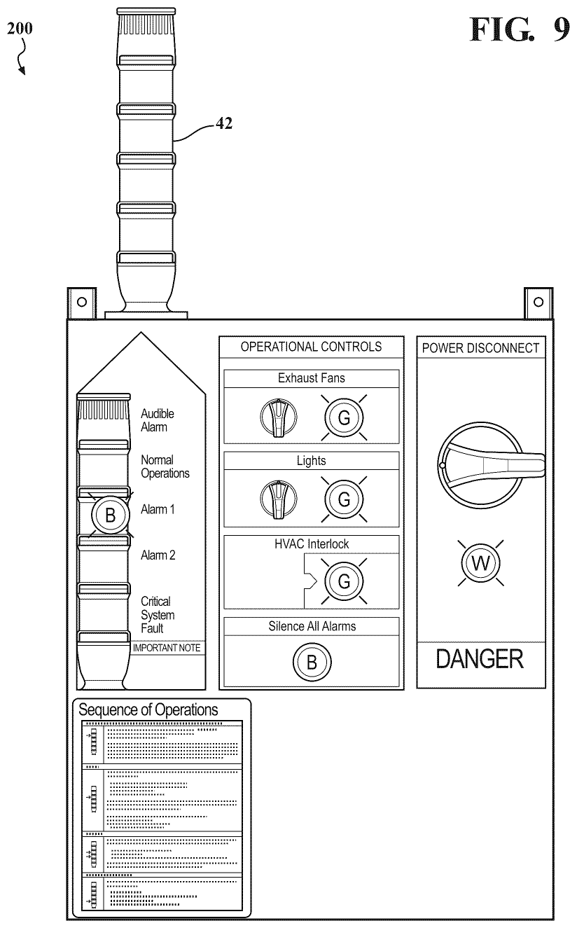

Initially, an auto-mode (110; FIG. 9) the FCEV service bay system 20 is always active such that the gas detection system 38 is constantly checking for hydrocarbons even when the control panel 200 is off. That is, when the control panel 200 is turned off, the auto-mode (110) is activated even though the light system 40 is off and the FCEV service bay system 20 is not being actively used.

### Normal Operations

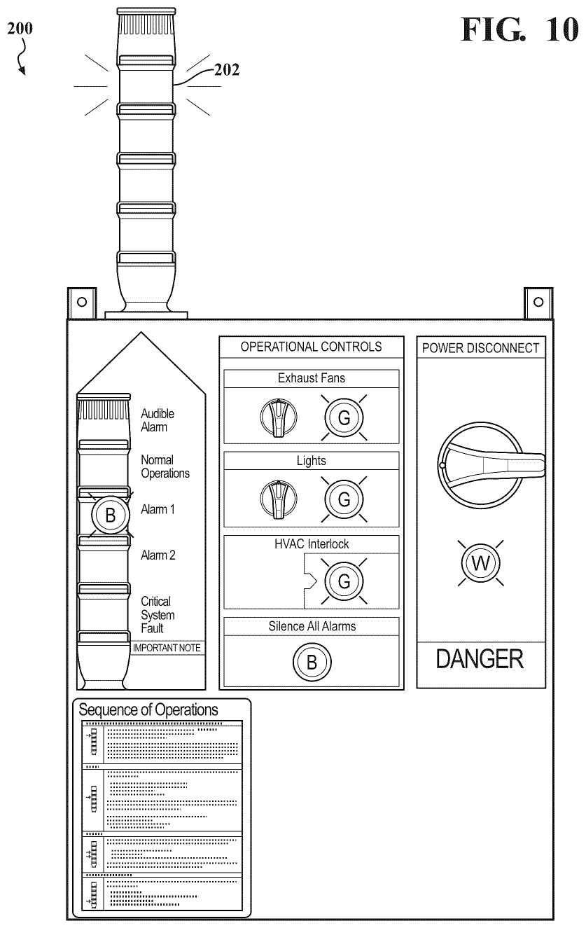

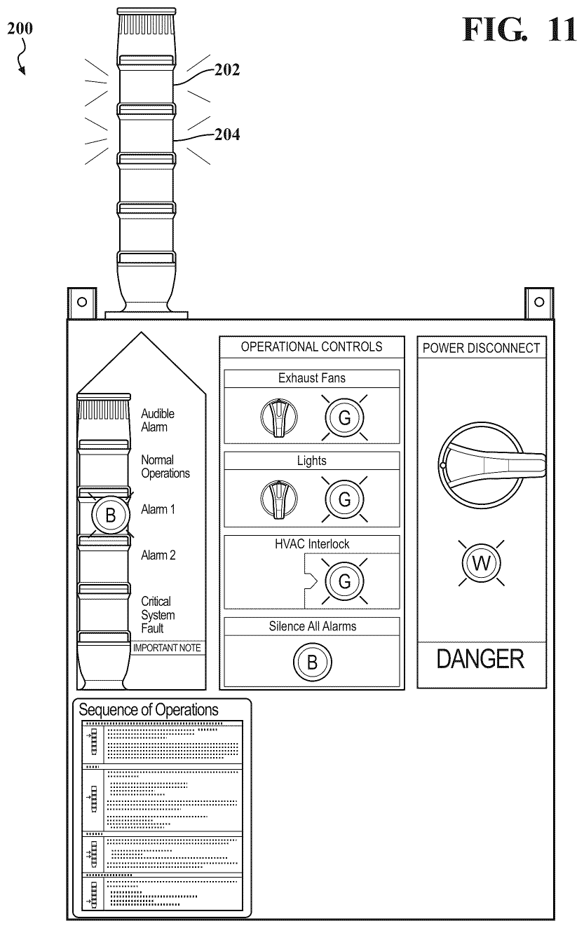

While in normal operation mode (120; FIG. 10) the gas detection system 38 is constantly checking for hydrocarbons and will alert a user to unsafe gas levels. This may be the daily startup to be performed when a main power panel light of the control panel 200 is on.

The circulation fans 66 may be activated by switching the control panel 200 from “Auto” to “on” such that the exhaust fans 66 will turn on to a preset “Normal” speed and the light system 40 may be switched from “off” to “on”. The warning system 42 may illuminate a green “Normal Operations” beacon light 202 of a warning light Christmas tree 201 to indicate that everything has been turned on, that everything is functioning correctly, that there are no unsafe conditions within the service bay, and that normal daily operations, e.g., vehicle repair service, can begin safely.

If the gas detection system 38 detects unsafe condition inside the service bay, e.g., preset lower flammability level (LFL) saturation levels, the alarm descriptions below are activated to resolve the unsafe condition. The lower flammability limit value of a gas is the lowest gas concentration that will support a self-emitting flame when mixed with air. Below the lower flammability limit, there is not enough fuel to support combustion; the fuel/air mixture is too weak, and no exacerbation will occur.

### Alarm 1

If the gas detection system 38 detects an unsafe condition inside the service bay, an “Alarm 1” mode (130; FIG. 11) is activated. The “Alarm 1” mode may occur at a preset LFL saturation level such as, for example, 10%, such that the FCEV service bay system 20 will exhibit the following behavior: the green “Normal Operations” beacon light 202 will turn off and a blue “Alarm 1 Acknowledge” beacon light 204 turns on and the circulation fans 66 of the gas exhaust system 36 increases to 100% speed. This collective behavior is referred to herein as an “Alarm 1” event that may automatically resolve an unsafe internal condition without user intervention.

Upon completion of a successful alarm 1 cycle, the service bay will then exhibit the following behavior: a blue ‘Alarm 1 Acknowledge’ panel light stays on (must be pushed to turn off) the blue “Alarm 1 Acknowledge” beacon light 204 turns off; the green “Normal Operations” beacon light 202 turns on and the circulation fans 66 of the gas exhaust system 36 slow to a normal operation speed.

### Alarm 2

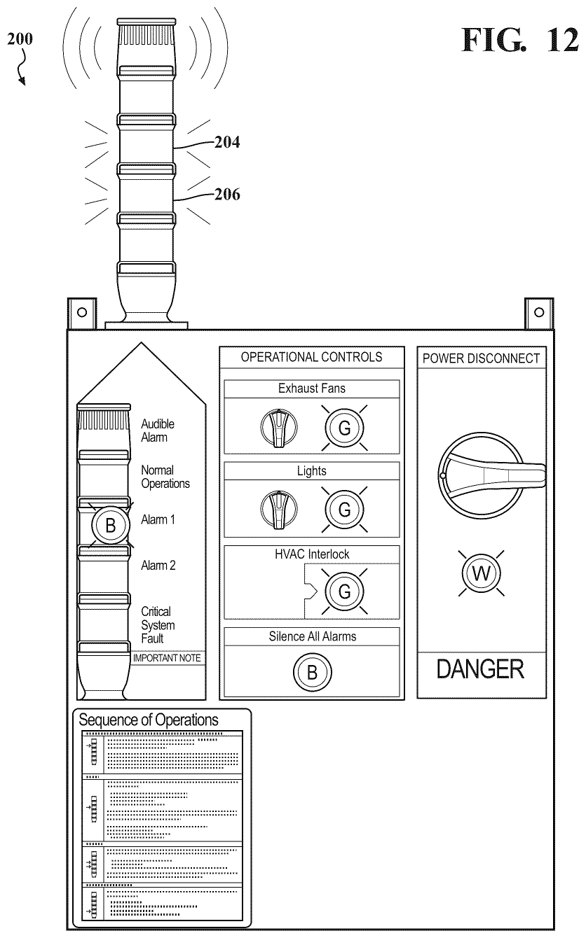

If the alarm 1 cycle did not resolve the unsafe condition, and the gas detection system 38 detects a hydrogen level that reaches, for example, 25% LFL an “Alarm 2” mode (140; FIG. 12) is activated. The FCEV service bay system 20 will then exhibit the following behavior: an amber “Alarm w Acknowledge” beacon light 206 turns on; an audio alarm sounds; the “HVAC Interlock” indicator light turns off and the HVAC run signal is discontinued. This behavior will persist until the conditions that triggered the “Alarm 2” event are resolved. The FCEV service bay system 20 will then revert back to the Alarm 1 behavior described above.

### Critical Systems Fault

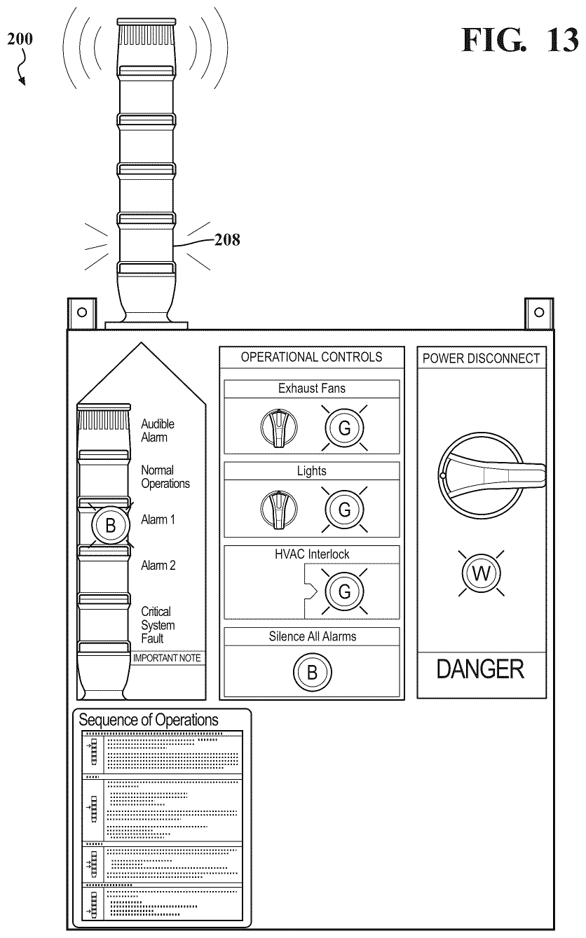

If a critical system fault has been detected, the FCEV service bay system 20 will enter a critical system fault mode (150; FIG. 13) and will exhibit the following behavior: an audio alarm sounds; the green “Normal Operation” light (which was on), will turn off; a red “systems fault” beacon light 208 will turn on; the green “HVAC Interlock” indicator light turns off.

The FCEV service bay system 20 provides an automatic safety control panel, an integrated gas detection system, visual and audio alarms, bright and highly efficient led lighting, optimized airflow design with dual speed for added safety, and an efficient use of electricity via a minimal full load amp draw.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed:

1. A Fuel Cell Electric Vehicles (FCEV) service bay system, comprising:
a vehicle bay roof structure that defines a first height from a ground surface;
a safety curtain mounted at least partially about a periphery of the vehicle bay roof structure, the safety curtain extends from the vehicle bay roof structure, the safety curtain defines a second height from the ground surface less than the first height;
a gas exhaust system mounted to the vehicle bay roof structure;
a gas detection system mounted to the vehicle bay roof structure; and
a control system in communication with the gas exhaust system and the gas detection system.

2. The FCEV service bay system as recited in claim 1, wherein the second height is less than one-third of the first height.

3. The FCEV service bay system as recited in claim 1, wherein a ratio of the safety curtain height to the height of the roof structure is between 0.2-0.5.

4. The FCEV service bay system as recited in claim 1, wherein a ratio of the safety curtain height to the height of the roof structure is 0.3.

5. The FCEV service bay system as recited in claim 1, further comprising a light system in communication with the control system.

6. The FCEV service bay system as recited in claim 1, further comprising a warning light Christmas tree in communication with the control system.

7. The FCEV service bay system as recited in claim 1, wherein the gas detection system is operable to detect a preset lower flammability level (LFL) saturation level.

8. A method for providing a predetermined lower flammability level (LFL) saturation level within a service bay for Fuel Cell Electric Vehicles (FCEV), comprising:
capturing lighter-than-air fuel within a predetermined height of a gas exhaust system mounted in a vehicle bay roof structure, the predetermined height less than a height of the vehicle bay roof structure to the ground; and
evacuating the lighter-than-air fuel to the atmosphere.

9. The method as recited in claim 8, wherein the capturing comprises extending a safety curtain from the vehicle bay roof structure.

10. The method as recited in claim 9, wherein a ratio of the safety curtain height to the height of the roof structure is 0.3.

11. The method as recited in claim 9, wherein the safety curtain extends for at least the predetermined height.

12. The method as recited in claim 9, wherein the evacuating comprises an updraft style air flow.

13. The method as recited in claim 8, further comprising detecting a lower flammability level (LFL) and issuing an alarm at a predetermined lower flammability level (LFL).
